(19) United States
(12) Patent Application Publication
(10) Pub. No.: US 2026/0021473 A1
(43) Pub. Date: Jan. 22, 2026

(54) THIOL-FUNCTIONALIZED ADSORBENTS FOR HEAVY METAL ION REMOVAL

(71) Applicants: UCHICAGO ARGONNE, LLC, Chicago, IL (US); THE UNIVERSITY OF CHICAGO, Chicago, IL (US)

(72) Inventors: Jeffrey W. ELAM, Elmhurst, IL (US); Vepa ROZYYEV, Palos Hills, IL (US)

(73) Assignees: UCHICAGO ARGONNE, LLC, Chicago, IL (US); THE UNIVERSITY OF CHICAGO, Chicago, IL (US)

(21) Appl. No.: 19/275,215

(22) Filed: Jul. 21, 2025

Related U.S. Application Data
(60) Provisional application No. 63/674,044, filed on Jul. 22, 2024.

(51) Int. Cl. B01J 20/32; B01J 20/28; B01J 20/34; C02F 1/28; C02F 101/20

(52) U.S. Cl. CPC B01J 20/3259; B01J 20/28016; B01J 20/28083; B01J 20/28085; B01J 20/3214; B01J 20/3236; B01J 20/3475; C02F 1/288; B01J 20/28019; C02F 2101/20

(57) ABSTRACT

A composition for removing heavy metal ions from an environment includes a porous particle having a plurality of pores, and a coating disposed on a surface of each pore of the plurality of pores. The coating includes a metal oxide layer on the surface of each pore of the plurality of pores and a silane-thiol layer on a surface of the metal oxide layer.

### CROSS-REFERENCE TO RELATED APPLICATION

This application claims the benefit of priority to U.S. Provisional Patent App. No. 63/674,044, filed Jul. 22, 2024, the entire contents of which is incorporated herein by reference.

### STATEMENT OF GOVERNMENT INTEREST

This invention was made with government support under Contract No. DE-AC02-06CH11357 awarded by the United States Department of Energy to UChicago Argonne, LLC, operator of Argonne National Laboratory. The government has certain rights in the invention.

### TECHNICAL FIELD

The present disclosure relates generally to thiol-functionalized adsorbents for heavy metal ion removal.

### BACKGROUND

Access to clean and safe drinking water is a fundamental human right, yet it remains a persistent global challenge due to the contamination of water sources with various pollutants. Heavy metal contamination is increasing in water sources due to increasing industrial and human activities, posing significant environmental and health hazards. Among these heavy metals, cadmium (Cd), arsenic (As), lead (Pb), mercury (Hg), and copper (Cu) are particularly harmful due to their toxicity and persistence in the environment. Arsenic, in particular, poses a serious global health problem, affecting several countries through its presence in natural groundwater sources.

### SUMMARY

There is a need for efficient and selective removal methods for water treatment processes. Thus, embodiments described herein relate generally to compositions of porous particles coated with metal oxides and silane-thiols and their use for the efficient and selective removal of heavy metals from aqueous solutions.

In an aspect, a composition includes a porous particle having a plurality of pores, and a coating disposed on a surface of each pore of the plurality of pores, the coating comprising a metal oxide layer on the surface of each pore of the plurality of pores and a silane-thiol layer on a surface of the metal oxide layer.

The metal oxide layer may have a thickness of about 0.1 nm to about 15 nm. The silane-thiol layer may have a thickness of about 0.1 nm to about 2 nm. About 60% to about 100% of the surface of each pore of the plurality of pores may be coated with the coating. The composition may have a pore volume of about 0.4 cm³/g to about 0.7 cm³/g. The metal oxide may include aluminum oxide, zinc oxide, magnesium oxide, manganese oxide, zirconium oxide, titanium oxide, tin oxide, cobalt oxide, silicon dioxide, indium oxide, niobium oxide, iron oxide, nickel oxide, gallium oxide, and yttrium oxide, or a combination of two or more thereof. The silane-thiol may include (O)ₐSi(O(CH₂)_{b}CH₃)_{c}(CH₂)_{d}SH, where a is 1-3, b is 0-2, c is 0-2, d is 1 to 10, and a+c=3. The silane-thiol may be present on the surface of the metal oxide layer in an areal density of about 3 molecules/nm² to about 4 molecules/nm². The porous particle may include silica, carbon, polymer, or a combination thereof. The plurality of pores of the porous silica particle may have an average diameter of about 20 nm to about 50 nm. The porous silica particle may have a diameter of about 10 μm to about 1000 μm.

In another aspect, a method of removing heavy metal ions from an environment includes contacting the heavy metal ions with any of the compositions disclosed herein, and adsorbing the heavy metal ions into the plurality of pores of the porous particle. The heavy metal ions may include mercury ions, arsenic ions, lead ions, cadmium ions, copper ions, or a combination of two or more thereof. The method may further include disposing any of the compositions disclosed herein in an aqueous solution of ethylenediaminetetraacetic acid (EDTA), removing at least some of the heavy metal ions; and reusing the composition to remove heavy metal ions from the environment.

In another aspect, a method of forming a composition includes depositing a metal oxide layer on a porous particle having a plurality of pores, and depositing a silane-thiol layer on the metal oxide layer. Depositing the metal oxide may include (A) introducing a metal precursor gas into the ALD reactor to form first precursor complexes on surfaces of the porous particle; and (B) introducing a co-reactant into the ALD reactor, the first co-reactant reactive with the first precursor complexes. Depositing the silane-thiol layer may include contacting the porous particle with a silane-thiol precursor having a structure according to Formula (I)

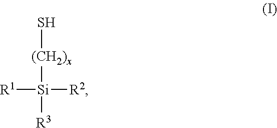

Wherein R¹, R², and R³ are each independently O(CH₂)_{y}CH₃ or (CH₂)_{y}CH₃, y is 0-2; x is 1-10; and at least two of R¹, R², and R³ are each independently O(CH₂)_{y}CH₃.

The metal precursor gas may include trialuminum and the co-reactant may include oxygen, ozone, hydrogen peroxide, water, or a combination of two or more thereof. The silane-thiol precursor may include (3-mercaptopropyl) trimethoxysilane, (3-mercaptopropyl) triethoxysilane, and (3-mercaptopropyl) methyldimethoxysilane, or a combination of two or more thereof. Depositing the metal oxide layer may include repeating steps (A) and (B) until a thickness of the metal oxide layer is about 0.1 nm to about 15 nm. Depositing the silane-thiol layer may include depositing a silane-thiol layer having a thickness of about 0.1 nm to about 2 nm. The porous particle may include silica, may have a diameter of about 10 μm to about 1000 μm, and may have an average diameter of about 20 nm to about 50 nm.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

FIG. 1A is a reaction scheme for the formation of the coating including a metal oxide layer and a silane-thiol layer. FIG. 1B shows atomic layer deposition (ALD) using different dose times for Al₂O₃ deposition onto porous SiO₂ particles. FIG. 1C shows ALD Al₂O₃ growth per cycle per surface area of porous SiO₂ particles. FIG. 1D shows deposition of silane-thiol on Al₂O₃ coated porous SiO₂ particles using different dose times. FIG. 1E shows deposition of silane-thiol on Al₂O₃ coated porous SiO₂ particles using different numbers of doses.

FIG. 2A shows N₂ adsorption isotherms of porous SiO₂ particles (“SiO₂”), porous SiO₂ particles coated with Al₂O₃ (“SiO₂-6×Al₂O₃”), or porous SiO₂ particles coated with Al₂O₃ and silane-thiol (SiO₂-6×Al₂O₃-Silane-SH”). FIG. 2B shows non-local density functional theory (“NLDFT”) pore size distributions of porous SiO₂ particles (“SiO₂”), porous SiO₂ particles coated with Al₂O₃ (“SiO₂—Al₂O₃”), and porous SiO₂ particles coated with Al₂O₃ and silane-thiol (SiO₂—Al₂O₃-Silane-SH″). FIG. 2C shows thermogravimetric analysis under oxygen flow for SiO₂, SiO₂—Al₂O₃, and SiO₂—Al₂O₃-Silane-SH. FIGS. 2D-2H show high resolution X-ray photoelectron spectroscopy (“XPS”) spectra of SiO₂—Al₂O₃-Silane-SH for C1s (FIG. 2D), Si2p (FIG. 2E), O1s (FIG. 2F), Al2p (FIG. 2G), and S2p (FIG. 2H).

FIGS. 3A-3F show removal efficiency selectivity. FIGS. 3A-3C show metal ion removal selectivity of SiO₂—Al₂O₃-Silane-SH at pH=4, 7, and 10, respectively. FIGS. 3D-3F show comparison of heavy metal ion removal efficiency of materials studied in this work at pH=4, 7, and 10, respectively.

FIGS. 4A-4E show Langmuir adsorption isotherms of SiO₂—Al₂O₃-Silane-SH for adsorption of Cd(II) (FIG. 4A), As(V) (FIG. 4B), Pb(II) (FIG. 4C), Hg(II) (FIG. 4D), and Cu(II) (FIG. 4E). FIGS. 4F-4J show time-dependent removal efficiencies for Cd(II) (FIG. 4F), As(V) (FIG. 4G), Pb(II) (FIG. 4H), Hg(II) (FIG. 41), and Cu(II) (FIG. 4J).

FIG. 5 shows breakthrough measurements of SiO₂—Al₂O₃-Silane-SH using a mixture of Cd(II), Pb(II), Cu(II), As(V), and Hg(II) ions with 5 ppm concentration for each ion at pH=4.

FIGS. 6A-6F shows adsorbent reusability studies of SiO₂—Al₂O₃-Silane-SH. FIG. 6A shows metal ion recoverability using 0.01 M HCl and 2 wt. % ethylenediaminetetraacetic acid (EDTA) solution. FIGS. 6B-6F shows adsorbent regeneration studies for three regeneration cycles of Cd(II) (FIG. 6B), As(V) (FIG. 6C), Pb(II) (FIG. 6D), Hg(II) (FIG. 6E), and Cu(II) (FIG. 6F) using 2 wt. % of EDTA solution. Adsorption measurements were performed at pH=4.

FIG. 7 is a schematic of Al₂O₃ ALD half reactions using trimethyl aluminum (“TMA”) and H₂O.

FIG. 8 shows Al₂O₃ ALD using TMA and H₂O using different N₂ purging times.

FIG. 9 is a reaction scheme for Silane-SH grafting on SiO₂—Al₂O₃.

FIGS. 10A-10E show high resolution XPS spectra of porous SiO₂ for C1s (FIG. 10A), Si2p (FIG. 10B), O1s (FIG. 10C), A12p (FIG. 10D), and S2p (FIG. 10E).

FIGS. 11A-11E show high resolution XPS spectra of porous SiO₂—Al₂O₃for C1s (FIG. 11A), Si2p (FIG. 11B), O1s (FIG. 11C), Al2p (FIG. 11D), and S2p (FIG. 11E).

FIG. 12 shows adsorption of heavy metal ions on SiO₂ and SiO₂—Al₂O₃surfaces under basic conditions.

FIGS. 13A-13E show pseudo-second-order kinetic model fitting of Hg²⁺ (FIG. 13A), Pb²⁺ (FIG. 13B), Cd²⁺ (FIG. 13C), As⁵⁺ (FIG. 13D), and Cu²⁺ (FIG. 13E) adsorption on SiO₂—Al₂O₃-Silane-SH using Eq. 11 from the Methods section below.

FIG. 14 is a schematic of the experimental setup for breakthrough adsorption measurements using a pipette.

FIG. 15 shows preparation and containment of a powder sample for ALD and vapor-phase silanization.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION OF VARIOUS EMBODIMENTS

Before turning to the figures, which illustrate certain exemplary embodiments in detail, it should be understood that the present disclosure is not limited to the details of methodology set forth in the description or illustrated in the figures. It should also be understood that the terminology used herein is for the purpose of description only and should not be regarded as limiting.

Conventional water purification methods for heavy metal ion removal include adsorption, membrane filtration, chemical precipitation, and electrochemical treatment. Among these methods, adsorption is a promising technology due to its low operating cost and simplicity, particularly for heavy metal ions at low concentrations. However, the regeneration of adsorbents after their use remains a substantial challenge. While conventional adsorbents, such as activated carbon, porous silica, and zeolite, are somewhat effective, these conventional adsorbents typically fall short in terms of specificity and efficiency, particularly in the presence of complex mixtures of various coexisting ions.

Thus, the present disclosure relates to compositions of porous particles coated with metal oxides and silane-thiols and their use for the efficient and selective removal of heavy metals from aqueous solutions. The porous particles may include a plurality of pores to create sufficient surface area for the adsorption and subsequent removal of heavy metals from aqueous solutions. The metal oxide layer may coat the porous particles, including inside of the pores of the porous particles, and the silane-thiol layer may be disposed on the metal oxide layer, including inside of the pores of the porous particles.

The coating may be disposed on a surface of each pore or a substantial portion of the plurality of pores. The substantial portion of the plurality of pores may be coverage greater than 50%, 60%, 70%, 80%, 90%, 95%, 98%, 99%, or 50% to 90%, 60% to 95%, 70% to about 98%, about 80% to about 99%, about 50% to 100%, about 60% to 100%, about 70% to 100%, or about 80% to 100%, about 90% to 100%.

The metal oxide layer of the coating on the porous particles may include a metal oxide that can be deposited with atomic layer deposition (ALD). For example, the metal oxide layer may include aluminum oxide, zinc oxide, magnesium oxide, manganese oxide, zirconium oxide, titanium oxide, tin oxide, cobalt oxide, silicon dioxide, indium oxide, niobium oxide, iron oxide, nickel oxide, gallium oxide, yttrium oxide, or a combination of two or more thereof.

The metal oxide layer may have a thickness that is predetermined to be thick enough to coat a substantial portion of the surface of the porous particles while also being thin enough to limit the decrease in pore size from coating the pores. The metal oxide layer may have a thickness of about 0.1 nm to about 20 nm, including about 0.1 nm to about 10 nm, about 0.1 nm to about 5 nm, about 0.2 nm to about 2 nm, about 0.2 nm to about 1 nm, or about 0.5 nm.

The metal oxide layer may have an areal density of at least about 30 ng/cm², at least about 60 ng/cm², at least about 120 ng/cm², at least about 160 ng/cm², at least about 170 ng/cm², at least about 180 ng/cm², about 30 ng/cm² to about 1000 ng/cm², about 40 ng/cm² to about 500 ng/cm², about 60 ng/cm² to about 300 ng/cm², 60 ng/cm² to about 200 ng/cm², about 180 ng/cm² to about 190 ng/cm², or about 185 ng/cm².

The silane-thiol layer may have a thickness that is predetermined to be thick enough to provide heavy metal ion interaction with the thiol groups, while also being thin enough to limit the decrease in pore size from coating the pores. The silane-thiol layer may have a thickness of about 0.1 nm to about 2 nm, including about 0.1 nm to about 1.5 nm, about 0.1 nm to about 1 nm, 0.1nm, 0.2 nm, 0.3 nm, 0.4 nm, 0.5 nm, 0.6 nm, 0.7 nm, 0.8 nm, 0.9 nm, 1 nm, 1.1 nm, 1.2 nm, 1.3 nm, 1.4 nm, 1.5 nm, 1.6 nm, 1.7 nm, 1.8 nm, 1.9 nm, or 2 nm. For example, the silane-thiol layer may be a monolayer having a thickness of about 0.1 nm to about 0.5 nm.

The silane-thiol layer may be present in an areal density of about 3 molecules/nm² to about 4 molecules/nm², including 3.0, 3.1, 3.2, 3.3, 3.4, 3.5, 3.6, 3.7, 3.8, 3.9, or 4.0 molecules/nm². For example, the silane-thiol layer may be present in an areal density of about 3.4 molecules/nm².

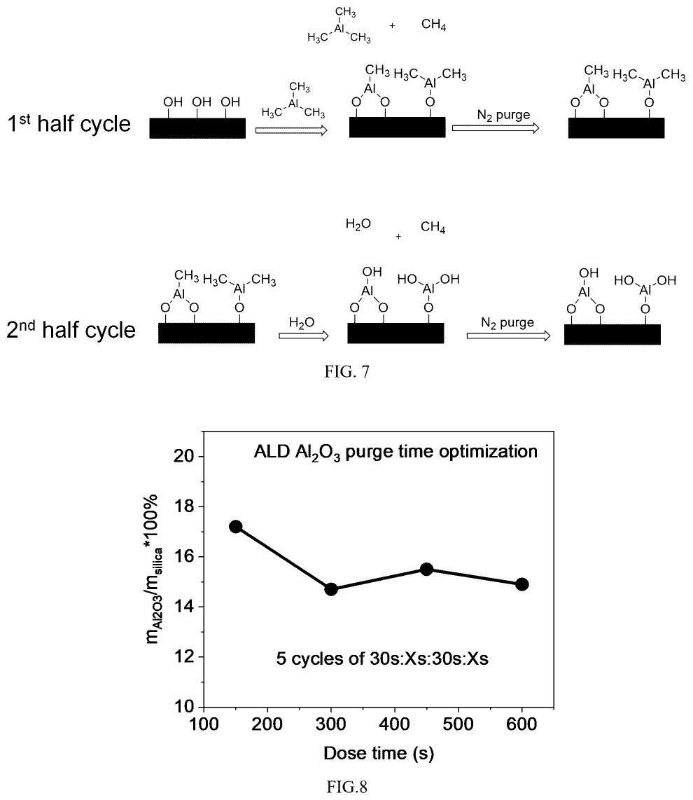

The silane-thiol layer may include species having the formula (O)₂Si(O(CH₂)_{b}CH₃)(CH₂)_{d}SH, where a is 1-3, b is 0-2, c is 0-2, d is 1 to 10, and a+c=3. The silane-thiol layer may include multiple forms of silane molecules, as illustrated in FIG. 9. For example, the silane-thiol layer may include (O)Si(O(CH₂)₆CH₃)₂(CH₂)_{d}SH and/or (O)₂Si(O(CH₂)_{b}CH₃)(CH₂)_{d}SH. In the formula, b may be 0, 1, 2; and d may be 1, 2, 3, 4, 5, 6, 7, 8, 9, or 10.

The composition may have a pore volume of about 0.2 cm³/g to about 1 cm³/g, about 0.3 cm³/g to about 0.8 cm³/g, about 0.4 cm³/g to about 0.7 cm³/g, about 0.5 cm³/g to about 0.7 cm³/g, or about 0.6 cm³/g.

The porous particles may include silica particles, carbon particles, polymer particles, or a combination thereof. The carbon particles may include graphite, carbon black, amorphous carbon, or a combination of two or more thereof. The polymer particles may include, for example, polyethylene, polypropylene, polyethylene terephthalate, polytetrafluoroethylene, nylon, or a combination or copolymer thereof.

The plurality of pores of the porous silica particle may have an average diameter, as measured by N2 adsorption isotherms, of about 10 nm to about 200 nm, about 10 nm to about 100nm, about 10 nm to about 80 nm, about 20 nm to about 50 nm, about 20 nm to about 40 nm, or about 30 nm.

The porous silica particle may have an average diameter, as measured by scanning electron microscopy, of about 10 μm to about 1000 μm, including about 20 μm to about 800 μm, about 30 μm to about 600 μm, about 40 μm to about 400 μm, about 50 μm to about 200 μm, about 60 μm to about 200 μm, or about 70 μm to about 200 μm.

In another aspect, a method of removing heavy metal ions from an environment includes contacting the heavy metal ions with any of the compositions disclosed herein, and adsorbing the heavy metal ions into the plurality of pores of the porous particle. Contacting may be conducted in aqueous solution, with the heavy metal ions dissolved in the aqueous solution. The aqueous solution may include a mixture of different ions, including heavy metal ions and not heavy metal ions, and the compositions disclosed herein may provide selective removal of heavy metal ions. The aqueous solution may have a pH of about 3 to about 11, but selectivity may be higher at about pH 7 or less, for example at about pH of 4.

Selective removal of heavy metal ions happens because heavy metal ions adsorb to the compositions disclosed herein more strongly than other ions, such that other ions that are incidentally adsorb to the composition may be displace by the heavy metal ions. Other ions may not adsorb to the composition, or may adsorb to the composition with weaker binding than heavy metal ions.

The heavy metal ions may be mercury ions, arsenic ions, lead ions, cadmium ions, copper ions, or a combination of two or more thereof. Other ions that do not adsorb or adsorb weakly to the composition include, but are not limited to, lithium, sodium, potassium, rubidium, magnesium, calcium, strontium, barium, manganese, cobalt, and nickel.

The aqueous solutions may have a concentration of heavy metal ions of about 0.1 ppm to about 1000 ppm, including about 0.2 ppm, about 0.5 ppm, about 1 ppm, about 2 ppm, about 5 ppm, about 10 ppm, about 20 ppm, about 30 ppm, about 40 ppm, about 50 ppm, about 60 ppm, about 70 ppm, about 80 ppm, about 90 ppm, about 100 ppm, about 200 ppm, about 300 ppm, about 400 ppm, about 500 ppm, about 600 ppm, about 700 ppm, about 800 ppm, about 900 ppm, about 1000 ppm, or any value therebetween, including about 1 ppm to about 10 ppm or about 1 ppm to about 100 ppm.

The composition may have a heavy metal ion removal capacity of about 1 mg/g to about 100 mg/g, including about 2 mg/g to about 80 mg/g, about 4 mg/g to about 60 mg/g, 6 mg/g to about 40 mg/g, 8 mg/g to about 30 mg/g, or about 10 mg/g to about 20 mg/g.

The method may further include recycling the compositions for further heavy metal ion removal. Recycling may include disposing the composition disclosed herein in an aqueous solution of ethylenediaminetetraacetic acid (EDTA) or hydrochloric acid (HCl) to remove at least some of the adsorbed heavy metal ions from the composition. Once the adsorbed heavy metal ions are removed, the composition may be reused to remove further heavy metal ions from the environment. The EDTA solution may have a concentration of about 1 wt. % to about 5 wt. %, including about 2 wt. %. The HCl solution may have a concentration of about 0.001 M to about 0.1 M, including about 0.01 M.

After removal, the composition may retain 50% to about 100% of its heavy metal adsorption, including about 60% to about 100%, 70% to about 99%, 80% to about 99%, or about 90% to about 99%. The amount of adsorption retained may vary depending on the type of heavy metal ion adsorbed, with Pb and Cu more easily removed from the composition that As and Hg.

In another aspect, a method is disclosed of forming the composition including porous particles and a coating on the porous particles, where the coating includes a metal oxide layer and a silane-thiol layer. The metal oxide layer may be deposited via thin film processing. The thin film processing may include atomic layer deposition (ALD). The surface of the porous particle, including inside of the pores, may act as the substrate upon which the metal oxide layer (also called a coating) is deposited.

The ALD process may include a first precursor. The first precursor may be, for example, a material reactive or absorbable on the substrate to form a first ALD intermediate. The ALD process may include a first co-reactant. The first co-reactant is reactive with the ALD first intermediate.

Each ALD process may include a cycle or multiple repeated cycles, where cycles may be repeated to form a predetermined film thickness. A cycle includes introducing a precursor into a reactor via a precursor vapor pulse for an exposure time, followed by a purge, such as where the reactor is pumped to a vacuum to remove excess precursor, followed by a co-reactant pulse with a co-reactant exposure time followed by a co-reactant purge. It should be appreciated that the dose and purge time may be based on the self-limiting behavior of the precursors/co-reactants and the desired precursor utilization efficiency. The exposure time can be varied in a wide range from a few milliseconds to tens of minutes. Further if a longer dose than purge time is utilized, the times may need to increase to avoid a CVD-type reaction, which can result in non-uniformity and particle formation.

Typically, the ALD process takes place in a uniform temperature-controlled reactor. In some embodiments, the substrate can be heated to a predetermined temperature during the ALD process. For example, the first predetermined temperature can be in the range of 50° C.-350° C. (e.g., 50, 60, 70, 80, 90, 100, 110, 120, 130, 140, 150, 160, 170, 180, 190, . . . 350° C., inclusive of all ranges and values therebetween). In some embodiments, the predetermined temperature is in the range of 100-350° C. (e.g., 150° C.). Temperature also impacts the overall energy in the system and the performance for diffusion and/or reaction. In a given ALD process, the deposition temperature range may be the temperature range in which ALD deposition occurs at an approximately static growth rate as function of temperature, which is referred to as the “ALD window.” The ALD reaction may occur at a temperature of the precursor sufficient to provide an approximately constant precursor evaporation rate (i.e., vapor pressure). If the precursor vapor pressure is insufficient to react with the reactive surface sites, there may still be layer growth, but the surface coverage may be less complete due to incomplete precursor saturation. If the vapor pressure is too high, precursor may be wasted, and CVD growth may occur if there is not sufficient purge time to remove the excess precursor. The temperature of the layer growth can be as low as the subliming or evaporation temperature of the ALD precursors. For example, if a precursor sublimes at 100° C., films may be grown around that temperature or a temperature higher than the sublimation temperature. Generally, layer growth temperature may be at least 10-50° C. higher than the precursor sublimation temperature. Further, a plasma may be used as the co-reactant or to enhance the growth rate or tailor the composition of the deposited layer or make the deposited material crystalline.

The metal precursor may be a vapor and the metal precursor pulse may introduce the metal precursor vapor into the reactor for a pulse time of a few milliseconds to tens of seconds (e.g., 0.005, 0.01, 0.05, 0.1, 0.5, 1, 5, 10, 20, or 30 seconds, inclusive of all ranges and values therebetween). The metal precursor partial pressure of the pulse can be in the range of 0.01-1000 Torr (e.g., 0.1, 0.2, 0.3, 0.4, 0.5, 0.6, 0.7, 0.8, 0.9, 1, 2, 3, 4, 5, 6, 7, 8, 9, 10, 25, 50, 75, 100, 500, or 1000 Torr, inclusive of all ranges and values therebetween), such as, for example, at least 0.3-100 Torr. One of skill in the art will appreciate that the time length, pressure, and amount of precursor for the pulse are all factors in determining the overall amount for each of those operation parameters. For example, the pressure and amount may follow from the duration of the pulse but depend on the size of the chamber and the type of valve as would be understood from general knowledge regarding ALD. Note, for ease of reference herein, the process is described with regard to the pulse duration, but it should be understood that the precursor partial pressure is another means to control the precursor dose. For spatial ALD, the precursor exposure is controlled by the amount of time the substrate (e.g., powder) spends in the precursor spatial domain and the precursor partial pressure in the precursor spatial domain. A carrier gas, such as nitrogen, argon, or other non-reactive (with the substrate or the precursors) gas, may be used.

The metal precursor exposure may include exposing the substrate (i.e., the porous particles) the to the metal precursor for a predetermined exposure time and a predetermined partial pressure so that the metal precursor adsorbs to the substrate or a coating from prior ALD cycles on the substrate or forms a reactive species complex with the substrate or the coating from prior ALD cycles. In some embodiments, given the brief time for the pulse/exposure for the ALD process the pulse lasts the entire exposure until the purge starts with the pulse time and exposure time being the same. The metal precursor pulse time may be less than the exposure time, or they may be equal such that the exposure is the same as the pulse. The metal precursor exposure time can be in the range of 0.5-2000 seconds (e.g., 0.5, 1, 5, 10, 20, 30, 40, 50, 60, 70, 80, 90, 100, 120, 140, 160, 180, 200, 220, 240, 260, 280, 300, 350, 400, 450, 500, 1000, or 2000 seconds, inclusive of all ranges and values therebetween), such as about 1 second. In some embodiments, the exposure time is in the range of 1-500 seconds. The partial pressure of the metal precursor can be in the range of 0.01-10 Torr (e.g., 0.01, 0.05, 0.1, 0.5, 1.0, 5.0, or 10 Torr, inclusive of all ranges and values therebetween). The partial pressure of the metal precursor may be in the range of 0.1-1 Torr. ALD growth can also be performed at various reactor pressures (e.g., 10 +Torr to 1000 Torr).

The metal precursor purge evacuates unreacted precursor from the reactor. The metal precursor purge may be for a precursor purge time of 0.5-2000 seconds (e.g., 0.5, 1, 5, 10, 20, 30, 60, 120, 240, 300, 400, 500, 1000, or 2000 seconds, inclusive of all ranges and values therebetween), such as 60 seconds. The precursor purge may evacuate the reactor such that the total pressure in the reactor is reduced substantially to vacuum. Alternatively, the precursor purge may consist of a constant flow of high purity carrier gas at a constant pressure that sweeps the unreacted precursor from the reactor. In either case, the precursor purge reduces the partial pressure of the precursor in the reactor by a factor of 10² to >10⁹ (e.g., from an initial value of 1 Torr immediately following the precursor exposure to a final value after the first precursor purge of 10⁻² to <10⁻⁹ Torr).

The substrate may be exposed to a co-reactant. The co-reactant is reactive with the metal precursor adsorbed on the substrate or reactive species complex resulting from the metal precursor's reaction with the substrate. The co-reactant is introduced into the reactor for a co-reactant exposure time and at a partial pressure of the co-reactant so that co-reactant reacts with the surface sites formed by the metal precursor reacting with the substrate (or previous ALD deposited coatings). The co-reactant exposure time can be in the range of 0.5-2000 seconds (e.g., 0.5, 1, 5, 10, 20, 30, 40, 50, 60, 70, 80, 90, 100, 120, 140, 160, 180, 200, 220, 240, 260, 280, 300, 350, 400, 450, 500, 1000, or 2000 seconds, inclusive of all ranges and values therebetween), such as about 1 second. The partial pressure of the co-reactant can be in the range of 0.01-10 Torr (e.g., 0.01, 0.05, 0.1, 0.5, 1.0, 5.0, or 10 Torr, inclusive of all ranges and values therebetween). In some embodiments, the partial pressure of the co-reactant is in the range of 0.1-1 Torr (e.g., about 0.5 Torr or 0.88 Torr). ALD growth can also be performed in various reactor pressures (10⁻⁴ Torr to 1000 Torr).

The co-reactant purge evacuates unreacted precursor from the reactor. The co-reactant purge may be for a co-reactant purge time of 0.5-2000 seconds (e.g., 0.5, 1, 5, 10, 20, 30, 40, 50, 60, 70, 80, 90, 100, 120, 140, 160, 180, 200, 220, 240, 260, 280, 300, 350, 400, 450, 500, 1000, or 2000 seconds, inclusive of all ranges and values therebetween), such as 60 seconds. The co-reactant purge may evacuate the reactor such that the total pressure is reduced substantially to vacuum. Alternatively, the co-reactant purge may consist of a constant flow of high purity carrier gas at a constant pressure that sweeps the unreacted co-reactant from the reactor. In either case, the co-reactant purge reduces the partial pressure of the co-reactant in the reactor by a factor of 10² to >10⁹ (e.g., from an initial value of 1 Torr immediately following the co-reactant exposure to a final value after the co-reactant purge of 10⁻² to <10⁻⁹ Torr).

The steps of introducing the metal precursor and then the co-reactant into the reactor as described above, which is 1 ALD cycle, may be repeated to deposit a uniform two-component coating on the substrate (e.g., only Al₂O₃, ZnO, or TiO₂). In some implementations, additional precursors and/or co-reactants may be sequentially introduced into the reactor as part of a supercycle. The ALD process may include a supercycle or multiple repeated supercycles. A supercycle combines ALD cycles for two or more ALD processes. For instance, a supercycle combining two ALD processes includes performing one or more ALD cycles for a first ALD process followed by one or more ALD cycles for a second ALD process. Supercycles may be used to form layered films, doped films, and/or gradient coating, as described above. Gradient coatings may be formed by varying the number of ALD cycles of each ALD process included in the supercycle as the coating is deposited.

It should be appreciated that more complicated ALD schemes can be constructed as super-cycles. Super-cycles may include various sub-cycles for depositing a material, for depositing multiple different materials, for multiple doped coatings, or for depositing bi-(tri-, etc.) metallic materials. The material deposited may vary based on the deposition parameters for any of the individual steps within a super-cycle. For example, the deposition may be a doped layer, a multi-layer, an alloy, a nanocomposite, or a mixed metal composite. The respective pulse and purge times may be the same time or may be different for the different metal precursors and co-reactants.

The metal precursor for depositing coatings including aluminum constituents may include, for example, trimethyl aluminum (TMA), triethyl aluminum, aluminum chloride, dimethyl aluminum isopropoxide, aluminum bromide, aluminum t-butoxide, tris(dimethylamido)aluminum (III), or aluminumacetylacetonate, or aluminum isopropoxide.

The metal precursor for depositing coatings including zinc constituents may include, for example, diethyl zinc, dimethyl zinc, zinc acetylacetonate hydrate, or bis(2,2,6,6-tetramethyl-3,5-heptanedionato) zinc.

The metal precursor for depositing coatings including magnesium constituents may include, for example, bis(cyclopentadienyl)magnesium, bis(ethylcyclopentadienyl)magnesium, bis(N,N′-di-sec-butylacetamidinato) magnesium, bis(pentamethylcyclopentadienyl)magnesium, or bis(2,2,6,6-tetramethyl-3,5-heptanedionato) magnesium.

The metal precursor for depositing coatings including zirconium constituents may include, for example, tetrakis(dimethylamino) zirconium (IV), tetrakis(diethylamino) zirconium (IV), tetrakis(ethylmethylamino) zirconium (IV), bis(cyclopentadienyl)dimethylzirconium, zirconium (IV) n-butoxide, zirconium (IV) t-butoxide, zirconium chloride, or zirconium (IV) i-propoxide.

The metal precursor for depositing coatings including titanium constituents may include, for example, titanium tetrachloride, tetrakis (diethylamino) titanium (IV), tetrakis (dimethylamino) titanium (IV), pentamethylcyclopentadienyltitanium trimethoxide, titanium t-butoxide, or titanium (IV) i-propoxide.

The metal precursor for depositing coatings including tin constituents may include, for example, tetrakis(dimethylamino) tin, tetrakis(diethylamino)tin, bis(N,N′-diisopropylformamidinato tin(II), tin chloride, tin iodide, tin t-butoxide, tetrakis(dimethylamido)tin(IV), tetrakis(diethylamido)tin(IV), tetramethyltin, tetraethyltin, tin(II) acetylacetonate, or dimethylamino-2-methyl-2-butoxy tin.

The metal precursor for depositing coatings including cobalt constituents may include, for example, N,N,N′,N′-tetramethylethylenediamine dichloride cobalt, bis (diisopropylbutanamidinate) cobalt, or dicobalt hexacarbonyl-1-heptyne.

The metal precursor for depositing coatings including silicon constituents may include, for example, silicon tetrachloride, tri-t-butoxysilanol, bis(dimethylamino)dimethylsilane, 3-aminopropyltriethoxysilane, or tris(dimethylamino)silane.

The metal precursor for depositing coatings including indium constituents may include, for example, trimethylindium, triethylindium, indium(III) triazenide, [3-(dimethylamino)propyl] dimethyl indium, [1,1,1-trimethyl-N-(trimethylsilyl)silanaminato]indium, or cyclopentadienyl indium.

The metal precursor for depositing coatings including niobium constituents may include, for example, trihydridobis(pentamethylcyclopentadienyl)niobium (V), niobium (V) ethoxide, niobium pentachloride, niobium pentafluoride, or (t-tutylimido) tris (diethylamino) niobium (V).

The metal precursor for depositing coatings including iron constituents may include, for example, bis(N, N′-diisopropyl-propionamidinate) iron, ethylferrocene, bis[bis(trimethylsilyl)amide]iron, or iron(III) tris(2,2,6,6-tetramethyl-3,5-heptanedionate).

The metal precursor for depositing coatings including nickel constituents may include, for example, dichlorobis(triethylphosphine)nickel(II), bis-methylcyclopentadienyl-nickel, or nickel (II) chloride.

The metal precursor for depositing coatings including gallium constituents may include, for example, gallium tri-isopropoxide, trimethylgallium, triethylgallium, or hexakis (dimethylamido) digallium.

The metal precursor for depositing coatings including yttrium constituents may include, for example, tris(butylcyclopentadienyl)yttrium, tris(ethylcyclopentadienyl) yttrium, tris(cyclopentadienyl)yttrium, tris[N,N-bis(trimethylsilyl)amide] yttrium (III), or yttrium (III) tris(2,2,6,6-tetramethyl-3,5-heptanedionate).

The co-reactant for depositing coatings including oxygen constituents may include, for example, water (H₂O), oxygen (O), ozone (O₃), hydrogen peroxide (H₂O₂), nitrous oxide (N₂O), or formaldehyde (CH₂O).

The silane-thiol layer may be deposited on the metal oxide layer. The silane-thiol layer may be deposited via silanization (also called surface functionalization with silane molecules or silane functionalization). The surface of the metal oxide layer and/or any exposed surface of the porous particle after metal oxide deposition, including inside of the pores of the porous particle, may act as the substrate upon which the silane-thiol layer (also called a coating) is deposited.

The silanization may include a silane-thiol precursor. The silane-thiol precursor may include, for example, an alkoxy group that may react with hydroxyl groups on the surface of the substrate, forming silane-thiol species covalently bonded to the substrate surface, and producing an alcohol as byproduct. The silane-thiol precursor may include a chloride group (Cl) or a dialkylammido group (NR₂).

The silane-thiol precursor may have a structure according to Formula (I)

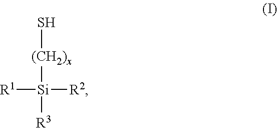

wherein
   R¹, R², and R³ are each independently O(CH₂)_{y}CH₃, or (CH₂)_{y}CH₃;
   y is 0-2;
   x is 1-10; and
   at least two of R¹, R², and R³ are each independently O(CH₂)_{y}CH₃.

In Formula (I), x may be 1, 2, 3, 4, or 5. For example, x may be 3, forming a mercaptopropyl. R¹, R², and R³ may each independently be CH₃, CH₂CH₃, or (CH₂)₂CH₃. In some embodiments, the silane-thiol may include one to three methoxy groups, as R¹, R², and/or R³, where y=0. For example, the silane-thiol may be a trimethoxysilane. As an example, the silane-thiol may be (3-mercaptopropyl) trimethoxysilane, (3-mercaptopropyl)triethoxysilane, (3-mercaptopropyl)methyldimethoxysilane, or a combination of two or more thereof.

The silanization may include one or multiple doses of the silane-thiol precursor. The doses may be introduced into the reactor successively, with pauses between doses. Optionally, there may be a purge between each dose, where the reactor is pumped to remove reacted species. The dose and purge times may be based on the self-limiting behavior of the silanization reaction and the desired precursor utilization efficiency. The exposure time of the substrate to the precursor can be varied in a wide range from a few milliseconds to tens of minutes.

The silanization may take place in a uniform temperature-controlled reactor. For example, silanization may follow ALD deposition using the same reactor and reactor conditions as the ALD deposition for ease and efficiency. In some embodiments, the substrate can be heated to a predetermined temperature during the silanization process. For example, the predetermined temperature can be in the range of 50° C.-350° C. (e.g., 50, 60, 70, 80, 90, 100, 110, 120, 130, 140, 150, 160, 170, 180, 190, . . . 350° C., inclusive of all ranges and values therebetween). In some embodiments, the predetermined temperature is in the range of 100-350° C. (e.g., 150° C.).

The silane-thiol precursor may be a vapor and the silane-thiol precursor pulse may introduce the silane-thiol precursor vapor into the reactor for a silane-thiol precursor pulse time of a few milliseconds to tens of minutes (e.g., 0.005, 0.01, 0.05, 0.1, 0.5, 1, 5, 10, 20, 30 seconds, 1, 2, 3, 4, 5, 6, 7, 8, 9, 10, 20, 30 minutes, inclusive of all ranges and values therebetween). The partial pressure of the silane-thiol precursor pulse can be in the range of 0.01-10 Torr (e.g., e.g., 0.01, 0.05, 0.1, 0.5, 1.0, 5.0, or 10 Torr, inclusive of all ranges and values therebetween), such as, for example, at least 0.1-1 Torr. One of skill in the art will appreciate that the time length, pressure, and amount of precursor for the pulse are all factors in determining the overall amount for each of those operation parameters. For example, the pressure and amount may follow from the duration of the pulse but depend on the size of the chamber and the type of valve as would be understood from general knowledge regarding silanization. Note, for ease of reference herein, the process is described with regard to the pulse duration, but it should be understood that the precursor partial pressure is another means to control the precursor dose. A carrier gas, such as nitrogen, argon, or other non-reactive (with the substrate or the precursors) gas, may be used.

The silane-thiol precursor exposure may include exposing the substrate (i.e., the porous particles) to the silane-thiol precursor for a predetermined exposure time at a predetermined partial pressure so that the silane-thiol precursor reacts with hydroxyl (OH) groups on the substrate surface. The silane-thiol precursor pulse time may be less than the silane-thiol exposure time, or they may be equal such that the exposure is the same as the pulse. The exposure time can be in the range of 0.5-2000 seconds (e.g., 0.5, 1, 5, 10, 20, 30, 40, 50, 60, 70, 80, 90, 100, 120, 140, 160, 180, 200, 220, 240, 260, 280, 300, 350, 400, 450, 500, 1000, or 2000 seconds, inclusive of all ranges and values therebetween), such as about 1 second. In some embodiments, the exposure time is in the range of 1-500 seconds. The partial pressure of the silane-thiol precursor can be in the range of 0.01-10 Torr (e.g., 0.01, 0.05, 0.1, 0.5, 1.0, 5.0, or 10 Torr, inclusive of all ranges and values therebetween). The partial pressure of the silane-thiol precursor may be in the range of 0.1-1 Torr. Silanization can also be performed at various reactor pressures (e.g., 10⁻⁴ Torr to 1000 Torr).

The silane-thiol precursor purge evacuates unreacted precursor from the reactor. The silane-thiol precursor purge may be for a purge time of 0.5-2000 seconds (e.g., 0.5, 1, 5, 10, 20, 30, 60, 120, 240, 300, 400, 500, 1000, or 2000 seconds, inclusive of all ranges and values therebetween), such as 60 seconds. The purge may evacuate the reactor such that the total pressure in the reactor is reduced substantially to vacuum. Alternatively, the purge may consist of a constant flow of high purity carrier gas at a constant pressure that sweeps the unreacted precursor from the reactor. In either case, the purge reduces the partial pressure of the precursor in the reactor by a factor of 10² to >10⁹ (e.g., from an initial value of 1 Torr immediately following the precursor exposure to a final value after the precursor purge of 10⁻² to <10⁻⁹ Torr).

The silane-thiol precursor may be pulsed into the reactor multiple times to provide sufficient precursor for coating the porous particles, since the porous particles have a higher surface area than a flat substrate. The silane-thiol precursor may be pulsed, 1-100 times (e.g., 1, 2, 3, 4, 5, 6, 7, 8, 9, 10, 20, 30, 40, 50, 60, 70, 80, 90, or 100 times). Pauses of predetermined length between pulses may provide time for the headspace in the silane-thiol precursor container to build up. For example, the pauses may be 1 second to 1 hour (e.g., 1 second, 5 seconds, 10 seconds, 30 seconds, 1 minute, 5 minutes, 10 minutes, 30 minutes, or 1 hour). A high purity carrier gas may be flowed over the headspace of the precursor container to increase the partial pressure of the precursor introduced into the reactor.

### EXAMPLES

Well-defined adsorption sites were prepared on high-surface area powders to examine the adsorptive removal of metal ions from aqueous solutions. In particular, porous silica gel was coated with ALD Al₂O₃ to prepare a hydroxylated surface. Following the ALD, the Al₂O₃-coated porous silica substrate was functionalized with (3-mercaptopropyl) triethoxysilane (“silane-thiol”) using vapor-phase silanization to introduce thiol functional groups to the adsorbent. The functionalized material was then tested for adsorptive removal of heavy metal ions. Results indicated that the thiol-functionalized adsorbent exhibited excellent selectivity in removing Cd, As, Pb, Hg, and Cu ions from aqueous solutions. This selectivity was maintained even in the presence of other ions including lithium (Li), sodium (Na), potassium (K), rubidium (Rb), magnesium (Mg), calcium (Ca), and barium (Ba), which often coexist in contaminated water sources. These studies indicated the use of ALD and vapor-phase silanization for the preparation of adsorbents targeting heavy metal ions in aqueous solutions.

The following Examples demonstrate the use of thiol-functionalized adsorbents, developed via ALD and vapor-phase silanization, for effectively and selectively removing heavy metal ions from water. The adsorbent showed remarkable efficiency in binding heavy metals, particularly under acidic conditions. The Langmuir isotherms and breakthrough studies confirmed the material's high affinity, especially for As (V) and Hg (II) ions. Additionally, kinetic studies highlighted the adsorbent's rapid removal of ions, underscoring its practical potential. In reusability studies, the thiol-functionalized adsorbent maintained a high adsorptive capacity for most of the heavy metal ions.

### EXAMPLE 1: Preparing a Coating of ALD Al₂O₃ and Silane-thiol on Porous Silica

Materials: Porous silica gel powder was purchased from SiliCycle (SiliaSphere S10040M, about 70 μm to about 200 μm particle size, average pore size of 30 nm). Trimethylaluminum (“TMA”) (98%) was purchased from Strem Chemicals, Inc. The deionized (“DI”) ACS reagent grade water was purchased from LabChem Chemical. Ultrahigh purity (“UHP”) inert nitrogen (N₂) gas was purchased from Airgas. Single-element aqueous standards of Cd, As, Pb, Hg, and Cu, each at 1000±3 ppm concentration in 2-3 wt. % HNO₃, and Nitric acid (HNO₃, 67-68 wt. %, trace metal grade) were purchased from Fisher Scientific Chemicals. (3-mercaptopropyl) triethoxysilane (“Silane-thiol”) (95%), 40 wt. % ethylenediaminetetraacetic acid (EDTA) aqueous solution, a multi-clement standard solution containing Li, Na, K, Rb, Mg, Ca, Sr, Ba, Mn, Co, Ni, Cd, As, Pb, and Cu, each at a concentration of 10.00±0.03 ppm in a 10 wt. % HNO₃, and a 1 M sodium hydroxide (NaOH) solution, were purchased from Millipore Sigma. Hydrochloric acid (HCl, 0.1 M) solution was purchased from Honeywell Fluka.

ALD and Vapor-Phase Silanization: The Al₂O₃ ALD and vapor-phase silanization reactions were carried out in a hot-wall viscous flow ALD reactor. Inert UHP N₂ gas was used as carrier gas maintaining a total mass flow rate of 300 sccm and a base pressure between 0.8-0.9 Torr. The reactor temperature was regulated within ±0.03° C. using proportional-integral-differential (“PID”) controllers. The Al₂O₃ ALD was done via self-limiting binary ALD reactions of TMA and water. The ALD method on 1 g of porous silica gel used a 30 second(s) TMA dose, followed by 300 s of N₂ purging, a 30 s water dose, and another 300 s of N₂ purging, repeated in the sequence (30 s:300 s:30 s:300 s) for each cycle. Before each experiment, the sample was installed in the reactor, where it underwent a 30 minute acclimatization period under the specified reaction conditions (300 sccm N₂ flow, 0.8-0.9 Torr, 150° C.). This step removed physisorbed water from the sample. During precursor dosing, TMA and water were kept at ambient temperature, and their partial pressures were each about 0.4 Torr, measured using a Baratron capacitance manometer. The silane-thiol reaction was carried out in the same reactor immediately after the Al₂O₃ ALD under the same temperature and flow conditions. The optimized method used ten exposures of a 20 s silane-thiol dose followed by 300 s of N₂ gas purging (10×(20 s: 300 s)). The silane-thiol was heated to 100° C. in a stainless-steel flow-through bubbler to reach a vapor pressure of about 0.02 Torr, and the precursor was carried by 50 sccm N₂ flow. Both the Al₂O₃ALD and the subsequent silanization processes were performed at 150° C.

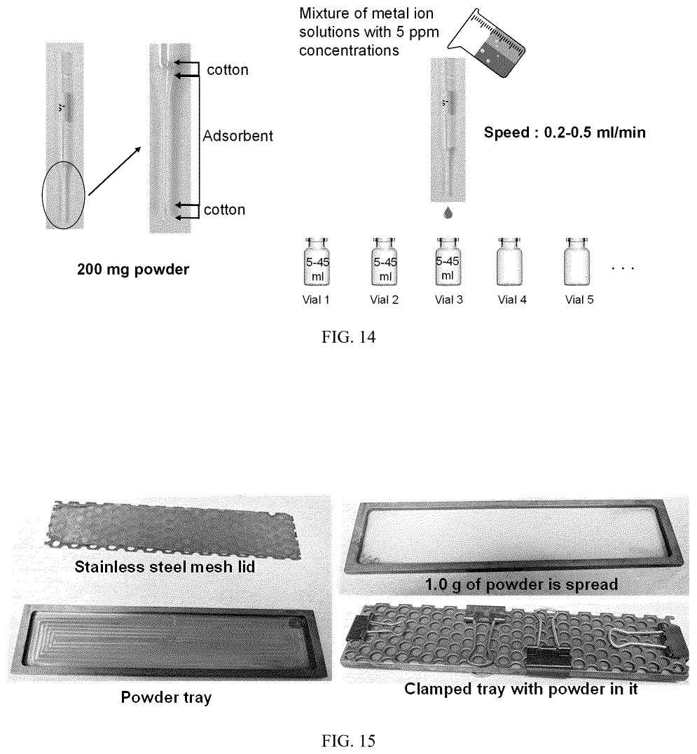

Weight gain measurements following ALD and vapor-phase silanization were conducted using a Mettler Toledo MS105 analytical balance. The balance features a capacity of 120 g and a readability of 0.1 mg. In each experiment, about 1.0 g of powder was evenly spread on a stainless-steel powder tray (FIG. 15). To prevent spillage, the tray was covered with a stainless-steel mesh lid, which was then securely clamped using clamps. The total mass of the sample, tray, lid, and clamps was recorded both before deposition and immediately after the completion of ALD or vapor-phase silanization. Prior to each deposition, the sample was placed in the reactor and left to acclimate for 30 minutes under reaction conditions (300 sccm N₂ flow, 0.8-0.9 Torr, 150° C.) to desorb any water adsorbed on the sample and tray. After the reaction, the clamped tray was immediately removed from the reactor and its weight was recorded.

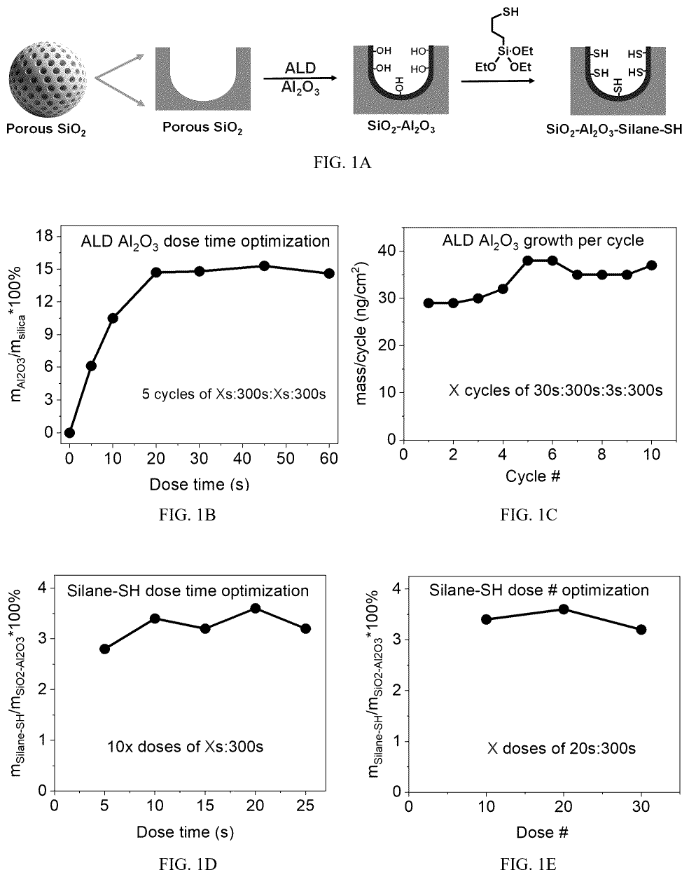

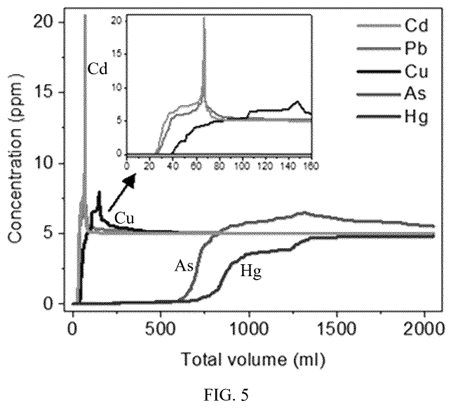

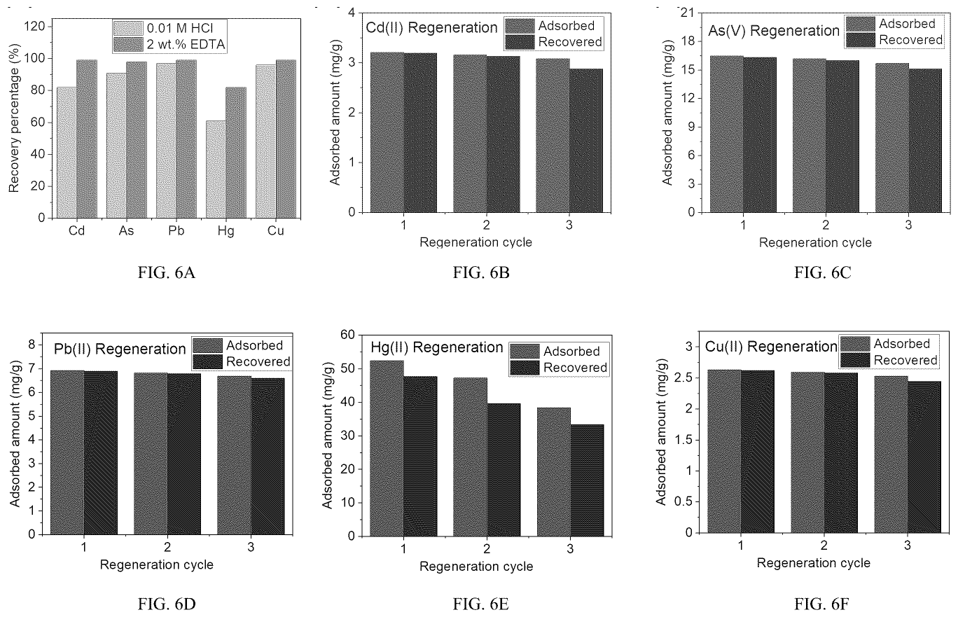

A commercial porous silica (SiO₂) gel powder was used as the substrate, characterized by a surface area of 88.8 m²/g, particle sizes ranging from 70 μm to 200 μm, and an average pore size of about 30 nm. In contrast to small-pore silicas, such as MCM-41 and SBA-15, which achieve size-selective separation through nm-scale confinement, this relatively large pore size silica gel was selected to deter or prevent confinement effects, thereby demonstrating the role of adsorptive binding. The two-step surface modification strategy involved ALD of Al₂O₃ and vapor-phase silanization of silane-thiol (FIG. 1A). SiO₂ powder was coated with ALD Al₂O₃ using trimethyl aluminum (“TMA”) and water (H₂O) at 150° C. For each ALD cycle, (1) TMA was dosed, (2) N₂ carrier gas was purged, (3) H₂O was dosed, and (4) N₂ carrier gas was purged sequentially, with dose and purge times designated as t_{TMA}:t_{N2}:t_{H2O}:t_{N2}. FIG. 7 is a schematic showing the mechanism of Al₂O₃ ALD. An aspect in coating porous materials via ALD as compared to planar surfaces is that longer precursor dosing is used to ensure that sufficient reactant is supplied to coat the higher surface area and enough time is allowed for the gas-phase reactants to diffuse through the smaller pores, thereby producing a conformal coating across all surfaces, including within the pores. To establish the saturation dose times for the Al₂O₃ ALD, samples were prepared using about 1.0 g SiO₂ powder with five TMA/H₂O ALD cycles, keeping the purge times constant at 300 seconds, and varying the precursor dose times (X_{TMA}:300 s:X_{H2O}:300 s). FIG. 1B shows the quantity of Al₂O₃ deposited measured using an analytical microbalance versus the precursor dose times. The results indicate that a dosing time of about 20 s was sufficient to achieve saturation on about 1.0 g of SiO₂ powder. Additionally, the saturation N₂ purge time was determined to be about 300 s, as shown in FIG. 8. Based on these measurements, the ALD Al₂O₃ timing sequence 30 s:300 s:30 s:300 s was used for the remainder of the work. Next, the Al₂O₃ growth per cycle (“GPC”) was measured from one to ten cycles using a microbalance and presented as mass per unit surface area of the initial SiO₂ (FIG. 1C). The GPC results revealed an initial value of 30 ng/cm² in the first ALD cycle. This rate increases to 38 ng/cm² over the first five cycles and then stabilized at about 37 ng/cm². This value aligned closely with previous measurements of Al₂O₃ ALD on planar surfaces using in-situ quartz crystal microbalance and ex-situ ellipsometry, suggesting that the high-surface-area silica gel achieved a steady state within the initial five cycles. These findings indicated that continuous Al₂O₃ coverage was achieved after five ALD Al₂O₃ cycles. Complete surface coverage was used because the Al₂O₃ layer establishes a robust and reactive surface for the silanization reaction. Consequently, porous SiO₂ was coated with five cycles of ALD Al₂O₃ (“SiO₂—Al₂O₃”) and this material was used for subsequent vapor-phase functionalization with silane-thiol.

Vapor-phase grafting of (3-mercaptopropyl)triethoxysilane (“silane-thiol”) onto the SiO₂—Al₂O₃was carried out at 150° C. to produce SiO₂—Al₂O₃-silane-thiol. The Silane-thiol molecule reacted with surface hydroxyls of SiO₂—Al₂O₃through its ethoxy group to form stable siloxy bonds and released ethanol by-product (FIG. 9). Without being bound by any particular theory, the incorporation of thiol groups may enhance the adsorbent's performance by imparting specificity toward heavy metal ions. The vapor-phase method provides surface functionalization without pore obstruction, which is useful for adsorption efficiency. Due to the low vapor pressure of silane-thiol (<0.02 Torr at 100° C.), multiple exposures of silane-thiol were used for functionalization. The reaction procedure (FIGS. 1D-1E) included 10 exposures, each comprising 20 s of silane-thiol dosing followed by 300 s of N₂ purging (10×(20 s:300 s)). Despite the extended exposure times and multiple doses, the total amount of reacted silane-thiol plateaued at about 3.6 wt. %, suggesting the formation of a self-terminating monolayer. Based on the surface area of SiO₂—Al₂O₃, the 3.6 wt. % silane-thiol reaction corresponds to a density of 3.4 molecules/nm². This value is comparable to previous coverage measurements on planar substrates (3.10-3.65 molecules/nm²), suggesting uniform monolayer coating on the porous SiO₂—Al₂O₃ substrate.

### Example 2: Characterization of ALD Al₂O₃ Layer and Silane-Thiol Layer

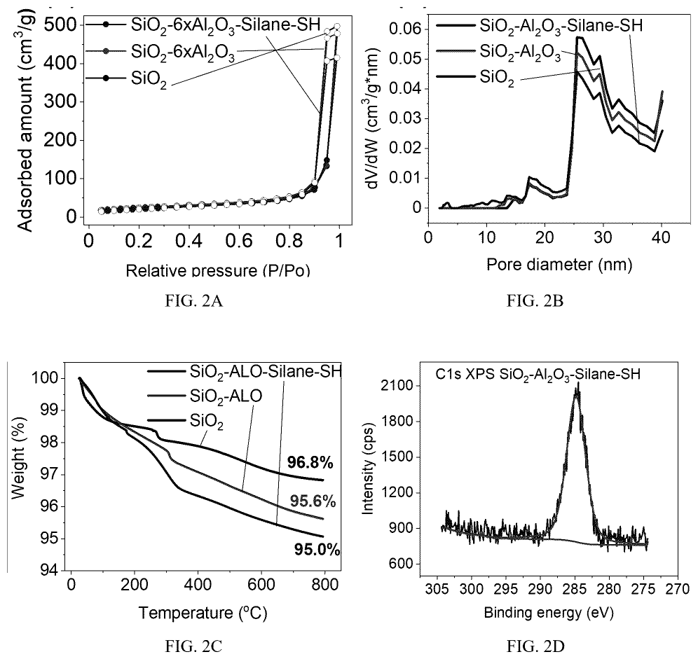

Given their high surface area, the porosities of SiO₂, SiO₂—Al₂O₃, and SiO₂—Al₂O₃-silane-thiol were analyzed using N₂ adsorption-desorption isotherms at 77 K (FIG. 2A). The Brunauer-Emmett-Teller (“BET”) surface areas remained relatively constant, showing a slight decrease from 88.7 m²/g to 82.7 m²/g after five Al₂O₃ ALD cycles, followed by a further minor reduction to 82.1 m²/g after the silane-thiol reaction (Table 1). These observations are consistent with previous reports of Al₂O₃ ALD on SiO₂ substrates. The decrease in surface areas is attributed to the increased specific mass of the powder. Pore size distributions were derived from non-local density functional theory (“NLDFT”) using a slit pore model on silica (FIG. 2B). The average pore diameter from FIG. 2B is 29.6 nm and is identical to the 30 nm pore size specified by the manufacturer. Similar to the surface areas, the pore size distributions also remained relatively constant after the Al₂O₃ ALD and Silane-thiol functionalization, except for a small decrease in pore volume attributed to the increased specific mass of the adsorbent. These observations suggest a uniform ALD coating and a monolayer Silane-thiol reaction within the porous silica substrate.

TABLE 1
Porosity analysis data and XPS elemental composition of
SiO₂, SiO₂—Al₂O₃, and SiO₂—Al₂O₃-silane-thiol.

| | Surface area | | XPS Elemental Analysis (atomic %) | | | | |
|---|---|---|---|---|---|---|---|
| Samples | (BET) | Pore volume | Si2p | O1s | Al2p | C1s | S2p |
| SiO₂ | 88.8 m²/g | 0.661 cm³/g | 33.17 | 64.69 | 0 | 2.14 | 0 |
| SiO₂—Al₂O₃ | 82.7 m²/g | 0.608 cm³/g | 13.09 | 55.61 | 17.20 | 14.10 | 0 |
| SiO₂—Al₂O₃- | 82.1 m²/g | 0.575 cm³/g | 16.94 | 52.19 | 17.06 | 12.03 | 1.78 |
| silane-thiol | | | | | | | |

X-ray photoelectron spectroscopy (XPS) analysis was conducted utilizing a Thermo Fisher K-Alpha+spectrometer, employing a microfocused monochromatic A1 Kα radiation source (1487 eV) with a 400 μm spot size. To collect survey scans, settings included a pass energy of 200.0 eV and a step size of 1.000 eV, while for high-resolution XPS scans, the parameters were adjusted to a pass energy of 50.0 eV and a step size of 0.100 eV. Data interpretation was performed by the Thermo Fisher Avantage software, with the protocol requiring the averaging of five scans per measurement. Calibration of all spectra was aligned with the C1s peak positioned at 284.8 eV. Powder specimens were prepared by compacting onto copper tape to mitigate charging artifacts common with insulating substrates, leveraging the conductive properties of copper foil.

Porosity and surface area characterization of the porous powders was obtained from N₂ adsorption isotherms at 77 K using an Anton Paar Quantachrome Autosorb iQ MP-MP automated gas sorption analyzer. For each measurement, 0.2-0.4 g of sample was used. Before each measurement, the samples were degassed at 150° C. for 6 hours (h) under a vacuum. The specific surface areas were derived from the Brunauer-Emmett-Teller (“BET”) method using linear fitting of 10 data points (P/Po=0.05-0.3). All pore size distributions were calculated using the Quantachrome ASiQwin software with a non-local density functional theory (“NLDFT”) equilibrium model for slit pores on silica surfaces.

To assess the thermal stability of the adsorbents, thermogravimetric analysis (“TGA”) was conducted up to 800° C. under an oxygen flow (FIG. 2C). After heating to 800° C., SiO₂, SiO₂—Al₂O₃, and SiO₂—Al₂O₃-Silane-thiol exhibited total mass losses of 3.2 wt. %, 4.4 wt. %, and 5.0 wt. %, respectively. Without being bound by any theory, these losses may be attributed to the desorption of adsorbed water, dehydration of surface hydroxyl groups, and decomposition of organic molecules. The greater hydroxyl density in ALD Al₂O₃ may account for the higher mass loss observed in SiO₂—Al₂O₃compared to SiO₂. The higher mass loss for SiO₂—Al₂O₃-silane-thiol may be due to its higher organic content. The TGA of SiO₂—Al₂O₃-silane-thiol exhibited a higher rate of mass loss at about 250° C., which may be attributed to the degradation of conjugated silane-thiol species.

Thermogravimetric analyses were performed on a Shimadzu TGA-55 by heating the samples from room temperature to 800° C. at a rate of 10° C. min⁻¹ under 50 mL/min oxygen flow. A platinum pan was used for the sample and referenced over the magnetic balances before each measurement.

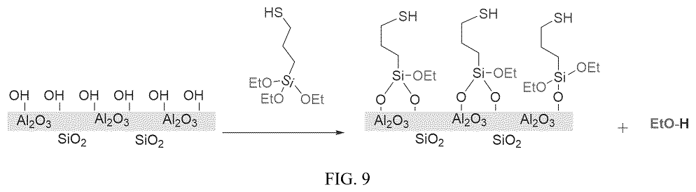

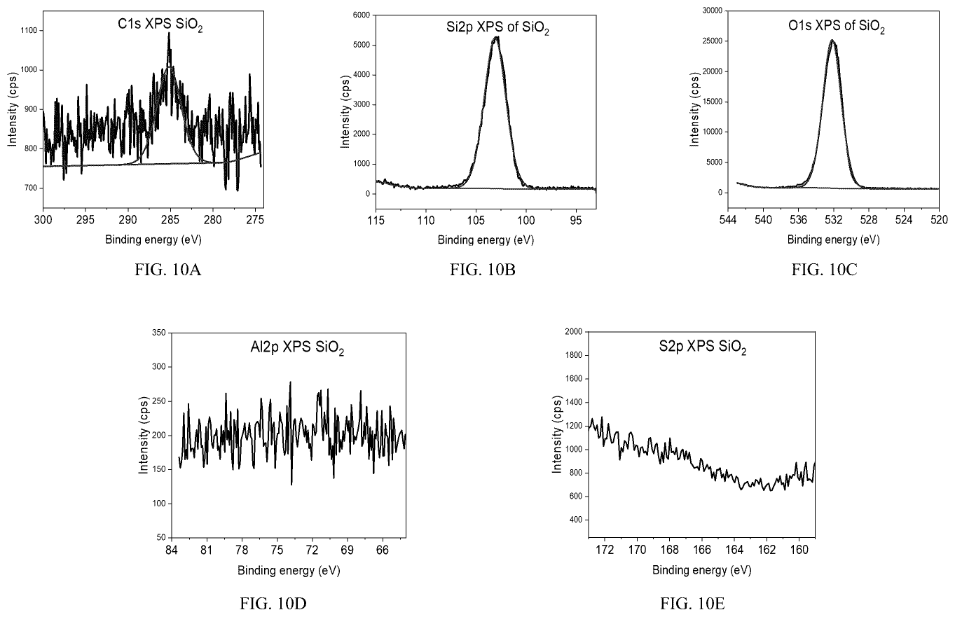

High-resolution XPS measurements of SiO₂—Al₂O₃-Silane-thiol revealed a characteristic Si2p peak at 103.2 eV and S2p peak at 163.8 eV (FIGS. 2E and 2H). These findings indicate the successful grafting of silane-thiol onto SiO₂—Al₂O₃. Additionally, the Al2p peak at 74.6 eV (FIG. 2G) and O1s peaks (FIG. 2F) at 531.1 eV (Al₂O₃) and 532.2 eV (SiO₂) corroborate the ALD Al₂O₃ coating on the SiO₂. Although the XPS analysis indicated an elemental S2p content of 1.78 at. % (Table 1), the actual content may be higher as the monolayer thiol is susceptible to damage under X-ray illumination. The XPS spectra of SiO₂, and SiO₂—Al₂O₃can be found in FIGS. 10A-10E and FIGS. 11A-11E, respectively.

The porosity analysis of the materials presented in FIG. 2 indicates the morphology of the pores. Mass gain measurements, combined with porosity analysis, suggest a uniform coating, as demonstrated in FIGS. 1 and 2.

### Example 3: Metal Ion Adsorption Selectivity

To assess the performance of the SiO₂—Al₂O₃-Silane-thiol for the selective removal of heavy metal ions, a mixture of 16 metal ions was prepared including the toxic heavy metal Cd (II), As (V), Pb (II), Hg (II), and Cu (II). Solutions at three distinct pH levels 4 (acidic), 7 (neutral), and 10 (basic) were prepared, with each ion at a concentration of 1 ppm. The concentration of metal ions in water before and after the adsorption measurements were measured using inductively coupled plasma optical emission spectrometry (“ICP-OES”).

Thermo Fisher iCAP PRO X Duo inductively coupled plasma-optical emission spectrometry (“ICP-OES”) was used to measure all metal ion concentrations reported in this study. Multi-clement standard solutions from Thermo Fisher were used to calibrate the instrument. Before conducting each ICP-OES measurement, concentrated HNO₃ (67 wt. %) was added to the analyte solutions to achieve a final concentration of 2 wt. % HNO₃, in accordance with the ICP-OES measurement procedure. The concentrations of metal ions in the analyte solutions were determined by extrapolating from the linear fitting of standard solutions to the intensity (counts per second) of the ICP-OES peaks. For metal selectivity tests, 1 ppm, 0.5 ppm, 0.2 ppm, and 0.1 ppm standard solutions were prepared by diluting commercial 10 ppm multi-element standard solutions with DI water. For the single-element analysis, 100 ppm, 50 ppm, 10 ppm, 5 ppm, 2 ppm, 1 ppm, 0.50 ppm, and 0.1 ppm solutions were prepared by diluting commercial 1000 ppm single-element standard solutions with DI water.

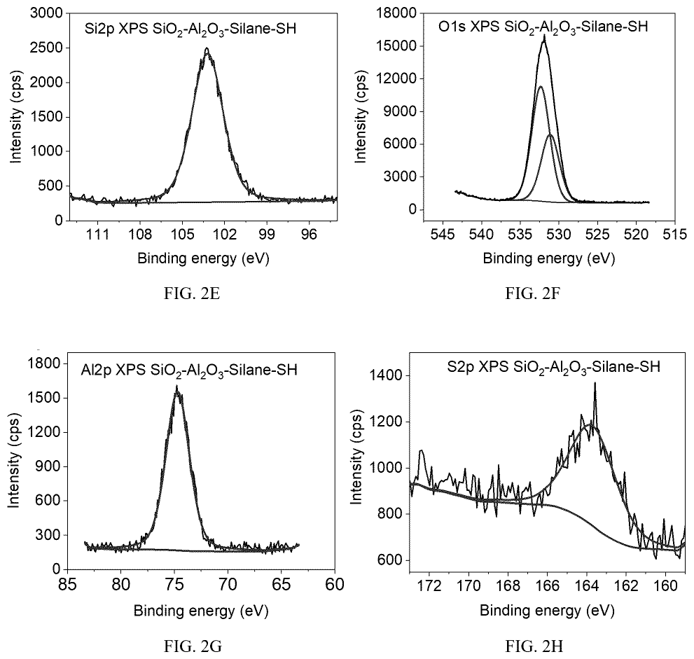

Under acidic conditions (pH=4), SiO₂—Al₂O₃-silane-thiol demonstrated selective removal of all five heavy metal ions (Cd, As, Pb, Hg, and Cu) with about 100% efficiency, while non-toxic alkali and alkaline earth metal ions (Li, Na, K, Rb, Mg, Ca, Sr, and Ba) and three transition metals (Mn, Co, and Ni) exhibited little to no adsorption (FIG. 3A). At neutral pH=7,while maintaining about 100% removal efficiency for the heavy metals, the adsorbent also showed 30-40% removal efficiency for Co(II) and Ni(II) (FIG. 3B). At basic pH=10, increased adsorption was observed for some alkali and alkaline earth metal ions as well, indicating that as the solution becomes more basic, a broader range of metal ion adsorption was observed (FIG. 3C). Metal ion adsorption onto SiO₂—Al₂O₃-silane-thiol involved three reactions: (1) the self-ionization of water, (2) the deprotonation of the thiol group, and (3) the subsequent chelation of metal ions by the thiolate anion, as described by the following equations:

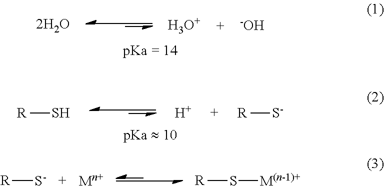

Thiols have a pKa of about 10, which, despite being more acidic than water, predominantly remain protonated at pH=4 ([R—S-]/[R-SH]≈10⁻¹⁰). Under acidic conditions, adsorption primarily occurs if the thiolate-metal binding (Eq. 3) is strong enough to drive the deprotonation of the thiol group (Eq. 2). Consequently, high selectivity for heavy metal ions at pH=4 was observed, aligning with the affinity of heavy metal ions for thiolate binding.

However, the adsorption mechanism described by Eqs. 1-3 may not fully apply to As (V) ions. In aqueous environments, As (V) primarily exists as different speciations of arsenic acid (H₃AsO₄) as illustrated in reactions (4) to (6):

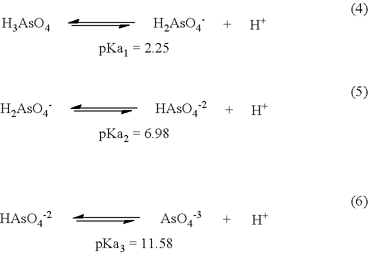

As a result, arsenic acid binds to thiolate through the release of a hydroxide ion from the arsenate, as shown in the reaction (7):

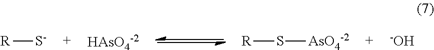

Consequently, although thiolate deprotonation is favored at higher pH levels, the arsenic acid binding to thiolate is disfavored under basic conditions. This results in a decrease in the removal efficiency of arsenic by SiO₂—Al₂O₃-silane-thiol, to 94% at a pH=10 (FIG. 3C).

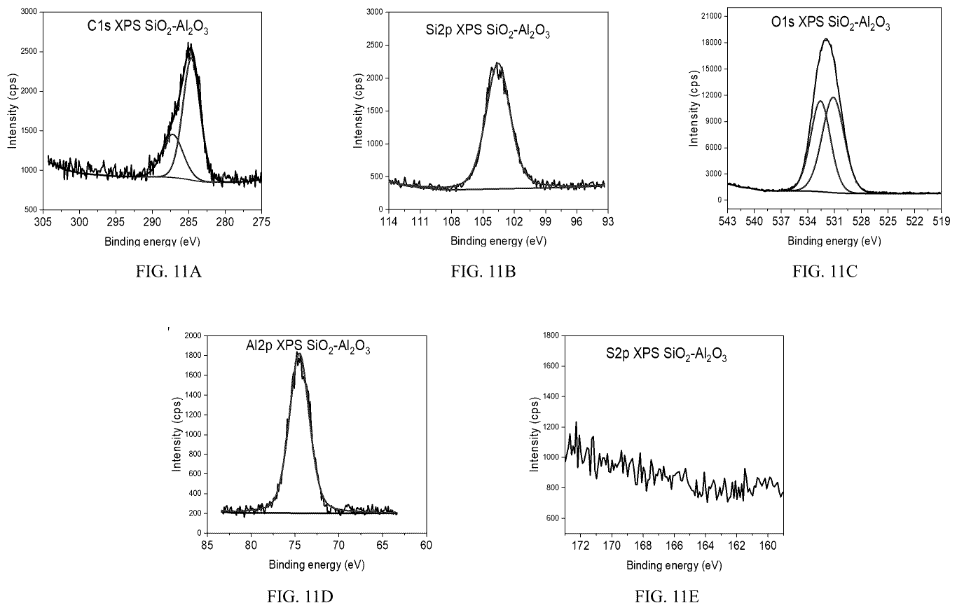

To indicate whether the higher removal efficiency of heavy metal ions is attributable to the composition with the silane-thiol layer, the performance of SiO₂ and SiO₂—Al₂O₃was compared with that of SiO₂—Al₂O₃-silane-thiol. The removal efficiencies were evaluated using mixtures of five heavy metal ions (Cd, As, Pb, Hg, and Cu) at pH levels of 4, 7, and 10 (FIGS. 3D-3F). The results indicated composition with the silane-thiol layer increased the adsorption of heavy metal ions, particularly at pH=4. Furthermore, composition with the silane-thiol layer achieved near-complete removal efficiency for the heavy metals studied (Cd, As, Pb, Hg, and Cu) across all pH levels. Conversely, both unmodified SiO₂ and SiO₂—Al₂O₃exhibited improved removal efficiency as the solution became more basic. Without being bound by any theory, this observation may be attributed to two factors: (1) the deprotonation and increased reactivity of surface hydroxyl groups on SiO₂ and Al₂O₃ facilitating binding with metal ions in the solution (FIGS. 12), and (2) the propensity for heavy metal ions to form less soluble metal hydroxides, thereby enhancing their removal. These mechanisms may be less effective under acidic conditions where hydroxide complexation is decreased. It should also be noted that SiO₂—Al₂O₃exhibited higher removal compared to the uncoated SiO₂. Specifically, for Cu(II), Pb(II), and Hg(II), SiO₂—Al₂O₃achieved approximately 98% removal efficiency at pH=4, which was similar to SiO₂—Al₂O₃-silane-thiol. Without being bound by any theory, this increased removal may be related to (1) the higher hydroxyl density of Al₂O₃ (8.7 OH nm⁻²) compared to SiO₂ (2.5 OH nm⁻²), and (2) the greater reactivity of hydroxyls on Al₂O₃ compared to SiO₂. On the silane-thiol grafted surface, about 30% of the Al₂O₃ hydroxyl groups remain unreacted in addition to the integrated thiol functionalities. As a result, SiO₂—Al₂O₃-silane-thiol exhibited the combined adsorptive characteristics of both SiO₂—Al₂O₃and silane-thiol, making it a better adsorbent compared to uncoated SiO₂ and SiO₂—Al₂O₃.

For the metal adsorption selectivity tests, 10 ppm multi-element standard solutions were diluted using DI water to obtain 1 ppm multi-element mixture solutions. The pH of these solutions was adjusted to 4, 7, and 10 by titration with 1 M and 0.1 M NaOH solutions. For adsorption measurement, 20 mL of the mixed ion solution at 1 ppm was added to 40-60 mg of adsorbent powder in a vial with a stirring bar. The mixture was then stirred continuously for 48 hours. After stirring, a 3-5 mL sample of the suspension was extracted using a syringe and filtered through a Whatman 0.2 μm syringe filter. The filtered solution was then analyzed using ICP-OES. The metal ion removal efficiencies were calculated using the equation:

$$Removal effieciency ( \% ) = \frac{{C}_{o} - {C}_{e}}{{C}_{o}} \times 100 \% \qquad ( 8 )$$

where Cₒ is the initial concentration of each ion before the adsorption measurement. Cₑ is the equilibrium concentration of metals after the adsorption measurement.

### Example 4: Langmuir Adsorption Isotherms

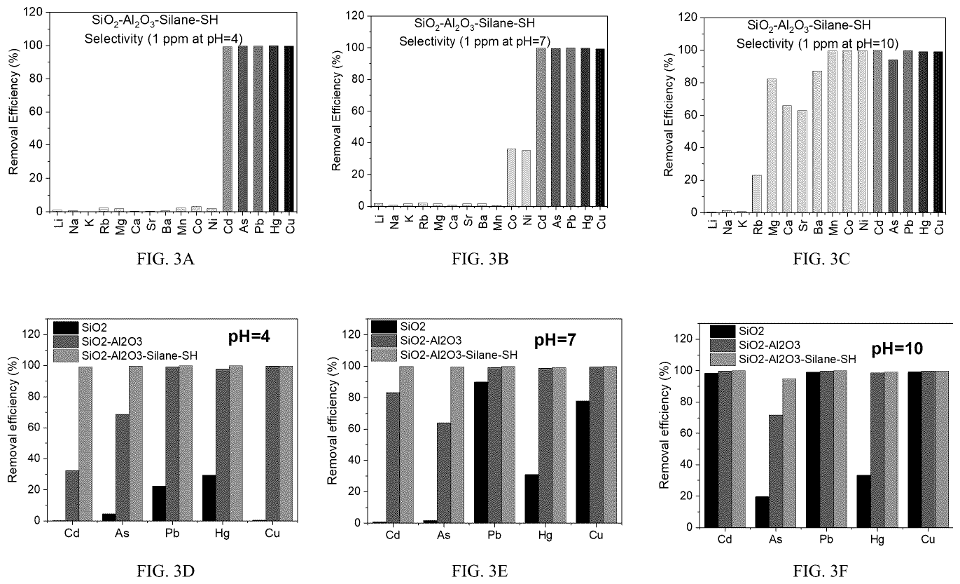

To study the adsorption behavior of SiO₂—Al₂O₃-silane-thiol for each metal ion, Langmuir adsorption isotherms were obtained by measuring the adsorption capacities at varying equilibrium concentrations using single metal ion solutions at pH=4 and fitting the data using Eq. 11 (FIGS. 4A-4E).

The equilibrium adsorption capacity of the adsorbents was calculated from the equation below:

$${Q}_{e} = \frac{( {C}_{o} - {C}_{e} ) V}{m} \qquad ( 10 )$$

where Cₒ (ppm) is the initial concentration of each ion before the adsorption measurement. Cₑ (ppm) is the equilibrium concentration of metals after the adsorption measurement, V is the solution volume (L), and m (g) is the mass of the adsorbent used.

For the equilibrium adsorption measurements, aqueous solutions of Cd, As, Pb, Hg, and Cu with concentrations ranging from 10 ppm to 100 ppm were prepared from 1000 ppm single-element standard solutions. The pH of these solutions was adjusted to 4 using a NaOH solution. Subsequently, 40-90 mg of adsorbent powder and 20 mL of the solution were added to a vial, and the mixture was stirred for 48 hours. After stirring, a 3-5 mL sample of the mixture was extracted and filtered through a Whatman 0.2 μm syringe filter. The filtered solutions were then analyzed using ICP-OES.

Equilibrium adsorption capacities and equilibrium concentrations were fitted based on a single-site Langmuir adsorption model:

$$\frac{{C}_{e}}{{Q}_{e}} = \frac{{C}_{e}}{{Q}_{m}} + \frac{1}{{Q}_{m} * {K}_{L}} \qquad ( 11 )$$

where Qₘ (mg/g) is the maximum adsorption capacity and K_{L} (L/mg) is the Langmuir constant.

The isotherms provide insights into adsorption capacities (Qₘₐₓ) and the Langmuir constant (K_{L}) of SiO₂—Al₂O₃-silane-thiol, where K_{L} indicates binding strength. Essentially, a higher K_{L} value implies a stronger binding affinity between the adsorbent and the adsorbate. The measured Qₘₐₓ values and the theoretical 1:1 binding capacity between the SiO₂—Al₂O₃-silane-thiol and metal ions are presented in Table 2. The molar Qₘₐₓ values showed a direct correlation with the K_{L} values, indicating that higher K_{L} values result in higher Qₘₐₓ values. This can be explained by the driving equilibrium reaction (Eq. 3), where a higher equilibrium constant gives a higher [R—S-M⁽ⁿ⁻¹⁾⁺]/[R—S⁻] ratio. Notably, Hg(II) and As(V) have higher K_{L} values (0.987 mmol/g for Hg, 0.912 mmol/g for As), leading to higher Qₘₐₓ capacities (0.297 mmol/g for Hg, 0.272 mmol/g for As), surpassing a theoretical 1:1 binding capacity (0.251 mmol/g). Slightly higher capacities than the theoretical 1:1 binding capacity suggest that these ions also adsorb on Al₂O₃ surface hydroxyls in addition to thiolate binding. Similarly, Cu(II), Pb(II), and Cd(II) exhibit much lower K_{L} values, and therefore lower Qₘₐₓ values. The binding affinity of SiO₂—Al₂O₃-silane-thiol, as inferred from the K_{L} values, follows the order: Cd(II)<Pb(II)<Cu(II)<<As(V)<Hg(II), with As(V) and Hg(II) showing much stronger binding.

TABLE 2
Langmuir adsorption fitting parameters and kinetic
parameters of metal ion adsorption on SiO₂—Al₂O₃-
silane-thiol measured at pH = 4.

| | Max. | | Max. | | |
|---|---|---|---|---|---|
| | capacity | Stoichiometric | capacity | | k₂(rate |
| Metal | Qₘₐₓ | (100% 1:1 | Qₘₐₓ | K_{L} | constant) |
| Ions | (mg/g) | binding) | (mmol/g) | (mg/L) | g/μmol*min |
| Cd(II) | 3.66 ± | 28.22 mg/g | 0.033 | 0.063 | 4.72 |
| | 0.32 mg/g | | | | |
| Pb(II) | 7.18 ± | 52.01 mg/g | 0.035 | 0.075 | 3.73 |
| | 0.65 mg/g | | | | |
| Cu(II) | 2.89 ± | 15.95 mg/g | 0.046 | 0.106 | 4.51 |
| | 0.31 mg/g | | | | |
| As(V) | 20.4 ± | 18.81 mg/g | 0.272 | 0.912 | 3.75 |
| | 2.51 mg/g | | | | |
| Hg(II) | 59.5 ± | 50.35 mg/g | 0.297 | 0.987 | 162 |
| | 7.04 mg/g | | | | |

### Example 5: Time-Dependent Removal Studies

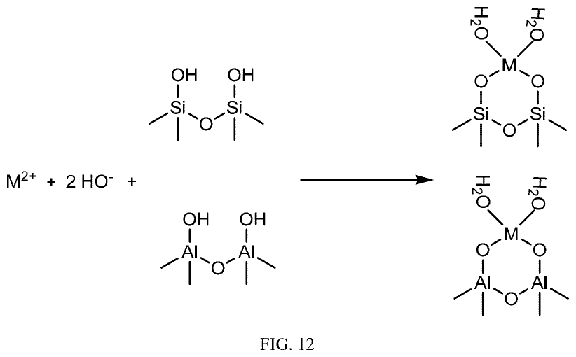

Understanding the kinetics of adsorption is vital for accurately predicting the rate of pollutant removal from aqueous solutions-a consideration in designing effective sorbents. To investigate this, time-dependent removal measurements were performed for SiO₂—Al₂O₃-silane-thiol with Cd(II), As(V), Pb(II), Hg(II), and Cu(II) ions, each metal ion solution a 5 ppm single metal ion solution at pH=4 (FIGS. 4F-4J). The removal kinetics were described by a pseudo-second-order kinetic model (Eq. 9), where the rate-limiting step is the adsorption of ions to the surface:

$$\frac{t}{{Q}_{t}} = \frac{t}{{Q}_{e}} + \frac{1}{{k}_{2} * {Q}_{e}^{2}} \qquad ( 9 )$$

where Qₜ (mg/g) is the adsorption capacity at a time t, and Qₑ (mg/g) is the equilibrium adsorption capacity, and k₂ is the rate constant. Pseudo-second-order model fitting plots can be found in FIGS. 13A-13E.

For the time-dependent adsorption study, 5 ppm each of Cd, As, Pb, Hg, and Cu solutions were prepared by diluting 1000 ppm standard solutions and adjusted to pH=4 using NaOH solution. Subsequently, 40-60 mg of adsorbent powder was mixed with 50 mL of the solution and immediately stirred. At certain time intervals, 3 mL samples were extracted using a syringe and then quickly filtered through a Whatman 0.2 μm syringe filter. The filtered solutions were then analyzed using ICP-OES.

Among the tested metal ions, mercury exhibited the most rapid removal as evidenced by the highest second-order rate constant (k₂), which agreed with its stronger binding affinity, as indicated by the Langmuir constants (Table 2). The k₂ values for Cu(II), Pb(II), and Cd(II) adsorption, while similar, also correlated broadly with their respective Langmuir constants. However, despite arsenic displaying a notably higher Langmuir adsorption constant, its k₂ value was low. Without being bound by any theory, this discrepancy may relate to the arsenic's adsorption mechanism (Eqs. 4-7). As previously discussed, arsenic predominantly exists in water as arsenic acid (H₃AsO₄).

### Example 6: Breakthrough Adsorption Studies

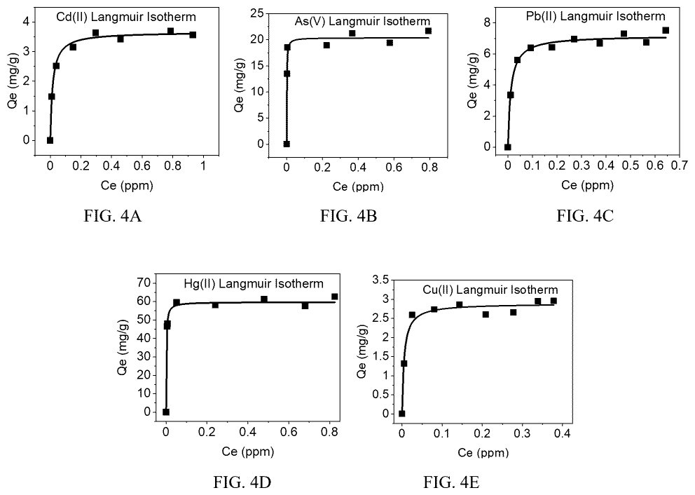

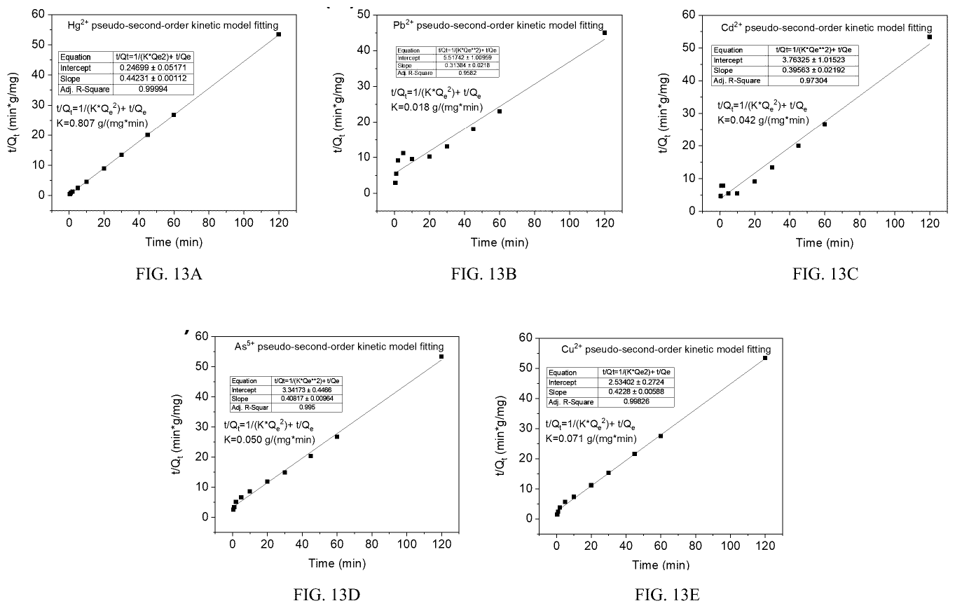

To further evaluate and compare the binding affinity of heavy metal ions to the SiO₂—Al₂O₃-silane-thiol adsorbent, a breakthrough adsorption study was conducted. This study included continuously flowing a mixture including 5 ppm of each of Cd(II), As(V), Pb(II), Hg(II), and Cu(II) ions through a packed bed containing 200 mg of SiO₂—Al₂O₃-silane-thiol (FIG. 14). This method was effective for precisely comparing ion binding affinities in a competitive setting as ions with weaker binding are displaced by those with stronger binding once the adsorption sites are saturated. Breakthrough data plotting the terminal ion concentrations versus the total volume of collected solutions are presented in FIG. 5. The inset of FIG. 5 shows that for the initial 21 mL of solution, the concentrations of all ions were almost undetectable, suggesting their complete adsorption. The breakthrough began with Cd(II) at 21 mL, followed by Pb(II) at 23 mL and Cu(II) at 31 mL. There was a significant gap until As (V) began to elute at 595 mL, and finally, Hg(II) was observed at 706 mL. The observed trend in the competitive adsorption process indicates the varying adsorption capacities and affinities of the ions, aligning with the order determined from the Langmuir adsorption isotherms: Cd(II)<Pb(II)<Cu(II)<<As(V)<Hg(II). After their breakthrough, the terminal concentrations of Cd(II), Pb(II), Cu(II), and As(V) initially rose above the original 5 ppm feed concentration before returning to the initial concentration. This trend indicates the displacement of weakly bound ions by strongly adsorbing As(V) and Hg(II), causing a temporary increase in concentration. At the end of the experiment, analysis revealed that all initially adsorbed Cd(II), Pb(II), and Cu(II) were fully displaced by As(V) and Hg(II), leaving only these ions adsorbed onto the SiO₂—Al₂O₃-silane-thiol.

For the breakthrough column separation studies, a mixed solution of Cd, As, Pb, Hg, and Cu was prepared with each ion at a concentration of 5 ppm and adjusted to a pH of 4. The column was prepared using a pipette filled with 200 mg of SiO₂—Al₂O₃-Silane-thiol powder, as described in FIG. 14. Cotton was placed at the tip of the pipette to prevent the powder from escaping, and additional cotton was placed on top of the powder to prevent its dispersion into the solution. The mixed solution was then passed through the column, and the effluent was collected in vials in increments of 5-45 mL. The mass of the collected liquid was precisely measured using a balance to determine the exact volume in each vial. Subsequently, the ion concentrations in these samples were analyzed using ICP-OES.

### Example 7: Recyclability of Adsorbents

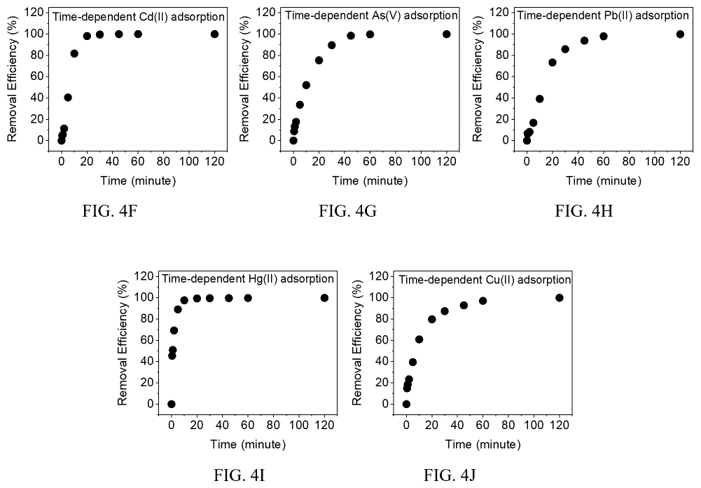

The reusability of adsorbents is useful for their eventual deployment in decontamination. In this study, the effectiveness of 0.01 M hydrochloric acid (“HCl”) and 2 wt. % ethylenediaminetetraacetic acid (“EDTA”) solutions in removing adsorbed heavy metal ions from SiO₂—Al₂O₃-Silane-thiol was investigated (FIG. 6A). The EDTA solution demonstrated better performance than HCl, achieving 99% recovery for Pb(II), Cu(II), and Cd(II), 98% for As(V), but only 82% for Hg(II). The regenerated SiO₂—Al₂O₃-silane-thiol was further assessed by repeating the adsorption-desorption process three times using the EDTA solution for all five ions to provide a comprehensive evaluation of their potential for repeated use in practical applications. As shown in FIGS. 6B-6E, SiO₂—Al₂O₃-silane-thiol maintained above 92% of its initial adsorptive capacity for Cd(II), As(V), Pb(II), and Cu(II) after three regeneration cycles using 2 wt. % of EDTA solution, underscoring its potential for reuse. However, its performance for Hg(II) was notably lower, retaining only 63% effectiveness, likely due to the incomplete desorption of Hg in previous cycles (FIG. 6F).

In the adsorbent reusability studies, 100 ppm solutions of single metal ions (Cd, As, Pb, Hg, and Cu) were prepared, and the pH was adjusted to 4. For the adsorption process, 100-120 mg of powder was added to 20 ml of each solution and stirred for 48 hours. Subsequently, for the desorption process, the powder was transferred to a column and washed with 200 ml of 2 wt. % EDTA solution. This adsorption-desorption cycle was repeated up to three times to assess the reusability of the materials.

### Definitions

No claim element herein is to be construed under the provisions of 35 U.S.C. § 112(f), unless the element is expressly recited using the phrase “means for.”

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above.

What is claimed is:

1. A composition comprising:
a porous particle having a plurality of pores, and
a coating disposed on a surface of each pore of the plurality of pores, the coating comprising a metal oxide layer on the surface of each pore of the plurality of pores and a silane-thiol layer on a surface of the metal oxide layer.

2. The composition of claim 1, wherein the metal oxide layer has a thickness of about 0.1 nm to about 15 nm.

3. The composition of claim 1, wherein the silane-thiol layer has a thickness of about 0.1 nm to about 2 nm.

4. The composition of claim 1, wherein about 60% to about 100% of the surface of each pore of the plurality of pores is coated with the coating.

5. The composition of claim 1, wherein the composition has a pore volume of about 0.4 cm³/g to about 0.7 cm³/g.

6. The composition of claim 1, wherein the metal oxide comprises aluminum oxide, zinc oxide, magnesium oxide, manganese oxide, zirconium oxide, titanium oxide, tin oxide, cobalt oxide, silicon dioxide, indium oxide, niobium oxide, iron oxide, nickel oxide, gallium oxide, yttrium oxide, or a combination of two or more thereof.

7. The composition of claim 1, wherein the silane-thiol comprises (O)^{a}Si(O(CH₂)_{b}CH₃)b(CH₂)_{d}SH, where a is 1-3, b is 0-2, c is 0-2, d is 1 to 10, and a+c=3.

8. The composition of claim 7, wherein the silane-thiol is present on the surface of the metal oxide layer in an areal density of about 3 molecules/nm² to about 4 molecules/nm².

9. The composition of claim 1, wherein the porous particle comprises silica, carbon, polymer, or a combination thereof.

10. The composition of claim 8, wherein the plurality of pores of the porous silica particle has an average diameter of about 20 nm to about 50 nm.

11. The composition of claim 9, wherein the porous silica particle has a diameter of about 10 μm to about 1000 μm.

12. A method of removing heavy metal ions from an environment comprising:
contacting the heavy metal ions with the composition of claim 1; and
adsorbing the heavy metal ions into the plurality of pores of the porous particle.

13. The method of claim 12, wherein the heavy metal ions comprise mercury ions, arsenic ions, lead ions, cadmium ions, copper ions, or a combination of two or more thereof.

14. The method of claim 12, further comprising:
disposing the composition of claim 1 in an aqueous solution of ethylenediaminetetraacetic acid (EDTA), removing at least some of the heavy metal ions; and
reusing the composition of claim 1 to remove heavy metal ions from the environment.

15. A method of forming a composition comprising:
depositing a metal oxide layer on a porous particle having a plurality of pores, the deposition including:
(A) introducing a metal precursor gas into the ALD reactor to form first precursor complexes on surfaces of the porous particle;
(B) introducing a co-reactant into the ALD reactor, the first co-reactant reactive with the first precursor complexes; and
depositing a silane-thiol layer on the metal oxide layer comprising contacting the porous particle with a silane-thiol precursor having a structure according to Formula (I) 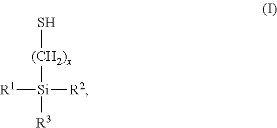
wherein:
R¹, R², and R³ are each independently O(CH₂)_{y}CH₃ or (CH₂)_{y}CH₃;
y is 0-2;
x is 1-10; and
at least two of R¹, R², and R³ are each independently O(CH₂)_{y}CH₃.

16. The method of claim 15, wherein the metal precursor gas comprises trimethylaluminum and the co-reactant comprises oxygen, ozone, hydrogen peroxide, water, or a combination thereof.

17. The method of claim 15, wherein the silane-thiol precursor comprises (3-mercaptopropyl)trimethoxysilane, (3-mercaptopropyl)triethoxysilane, (3-mercaptopropyl)methyldimethoxysilane, or any combination of two or more thereof.

18. The method of claim 15, wherein depositing the metal oxide layer comprises repeating steps (A) and (B) until a thickness of the metal oxide layer is about 0.1 nm to about 15 nm.

19. The method of claim 15, wherein depositing the silane-thiol layer comprises depositing silane-thiol layer having a thickness of about 0.1 nm to about 2 nm.

20. The method of claim 15, wherein the porous particle comprises silica, has a diameter of about 10 μm to about 1000 μm, and an average diameter of about 20 nm to about 50 nm.
